(19) United States
(12) Patent Application Publication
(10) Pub. No.: US 2014/0097802 A1
(43) Pub. Date: Apr. 10, 2014

(54) Charging System

(71) Applicant: NOVATEK MICROELECTRONICS CORP., Hsin-Chu (TW)

(72) Inventors: Wing-Kai Tang, Hsinchu City (TW); Cheng-Wen Chang, Hsinchu City (TW)

(73) Assignee: NOVATEK Microelectronics Corp., Hsin-Chu (TW)

(21) Appl. No.: 13/772,330

(22) Filed: Feb. 21, 2013

(30) Foreign Application Priority Data
Oct. 8, 2012 (TW) 101137094

(51) Int. Cl. H02J 15/00

(52) U.S. Cl. CPC H02J 15/00
USPC 320/166

(57) ABSTRACT

The present invention discloses a charging system for charging a capacitor. The charge system includes at least one unit gain buffer, driven by a plurality of driving voltages, each unit gain buffer having a positive input terminal for receiving a target voltage and a negative input terminal coupled to an output terminal, a plurality of switches coupled between the plurality of driving voltages and the capacitor, and a switch control waveform generator, coupled to the plurality of switches, for switching on one of the for a specific driving voltage among the plurality of driving voltages to drive one of the at least one unit gain buffer to charge the capacitor.

### BACKGROUND OF THE INVENTION

1. Field of the Invention

The present invention relates to a charging system, and more particularly, to a charging system capable of 2.

2. Description of the Prior Art

In general, when performing liquid crystal display (LCD) driving, a unit gain buffer is utilized to charge a capacitor of each pixel to a target voltage according to a gray scale of each pixel in each image, to display each image.

For example, please refer to FIG. 1, which is a schematic diagram of a conventional unit gain buffer 10 charging a capacitor 12. As shown in FIG. 1, the unit gain buffer 10 is driven by a driving voltage V_{P}, and includes a positive input terminal for receiving a target voltage V_{T}, and a negative input terminal coupled to an output terminal of the unit gain buffer 10 to form a negative feedback loop, to maintain the output terminal voltage at the target voltage V_{T}. Therefore, the capacitor 12 can be charged to the target voltage V_{T}. In such a condition, total power consumption caused by charging the capacitor 12 can be denoted as: P=I*V=(V_{T}*C*F)*V_{P}, wherein C is capacitance of the capacitor 12, and F is switching frequency of display image, i.e. the capacitor 12 is charged to the target voltage V_{T} in a period of 1/F.

However, the conventional method of charging the capacitor 12 with only the unit gain buffer 10 charges the capacitor by a fixed driving voltage, which may cause great power consumption when the target voltage is relatively low. Thus, there is a need for improvement of the prior art.

### SUMMARY OF THE INVENTION

It is therefore an objective of the present invention to provide a charging system capable of enabling a specific driving voltage among a plurality of driving voltages to drive a unit gain buffer to charge a capacitor according to a range which a target voltage is located, to reduce power consumption.

The present invention discloses a charging system, for charging a capacitor. The charging system comprises at least one unit gain buffer, driven by a plurality of driving voltages, each unit gain buffer comprising a positive input terminal for receiving a target voltage and a negative input terminal coupled to an output terminal of the each unit gain buffer; a plurality of switches, coupled between the plurality of driving voltages and the capacitor; and a switch control waveform generator, coupled to the plurality of switches, for switching on a specific switch of the plurality of switches within a period according to a control signal, to enable a specific driving voltage among the plurality of driving voltages to drive one of the at least one unit gain buffer to charge the capacitor.

The present invention further discloses a charging system, for charging a capacitor. The charging system comprises a unit gain buffer, comprising a differential input pair, driven by a maximum driving voltage among a plurality of driving voltages, and comprising a positive input terminal for receiving a target voltage, and a plurality of output stages, driven by the plurality of driving voltages respectively, and comprising a plurality of output terminals; a plurality of switches, coupled between the plurality of output terminals of the plurality of output stages and the capacitor; and a switch control waveform generator, coupled to the plurality of switches, for switching on a specific switch of the plurality of switches within a period according to a control signal, to enable a specific driving voltage among the plurality of driving voltages to drive one of the plurality of output stages to charge the capacitor; wherein a negative input terminal of the unit gain buffer is coupled to one of the plurality of output terminals of the plurality of output stages through the specific switch among the plurality of switches.

The present invention further discloses a charging system, for charging a capacitor. The charging system comprises a unit gain buffer, comprising a positive input terminal for receiving a target voltage and a negative input terminal coupled to an output terminal of the unit gain buffer; a plurality of switches, coupled between a plurality of driving voltages and the capacitor; and a switch control waveform generator, coupled to the plurality of switches, for switching on a specific switch of the plurality of switches within a period according to a control signal, to enable a specific driving voltage among the plurality of driving voltages to drive one of the at least one unit gain buffer to charge the capacitor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a unit gain buffer charging a capacitor.

FIG. 2A is a schematic diagram of a charging system according to an embodiment of the present invention.

FIG. 2B is a schematic diagram of a voltage to digital code conversion information.

FIG. 2C is a schematic diagram of dividing a driving voltage into three ranges.

FIG. 2D to FIG. 2F are schematic diagrams of three switches to be turned on in one cycle under different conditions.

FIG. 3 is a schematic diagram of another charging system according to an embodiment of the present invention.

FIG. 4 is a schematic diagram of another charging system according to an embodiment of the present invention.

FIG. 5 and FIG. 6 are schematic diagrams of another two charging system according to an embodiment of the present invention.

FIG. 7 and FIG. 8 are schematic diagrams of another two charging system according to an embodiment of the present invention.

FIG. 9 is a schematic diagram of another charging system according to an embodiment of the present invention.

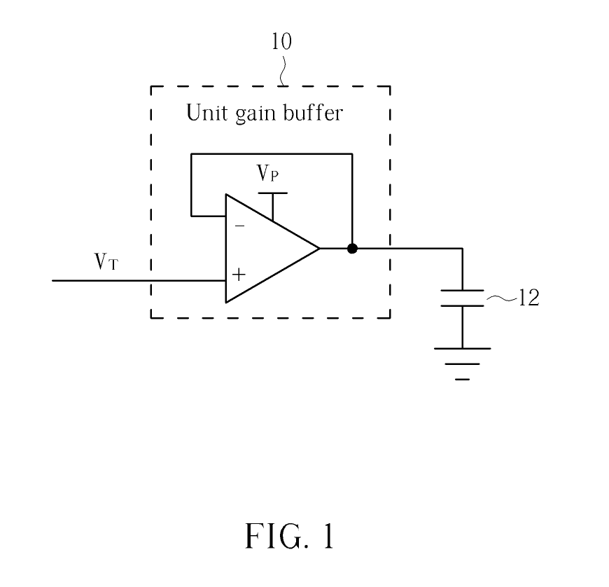

### DETAILED DESCRIPTION

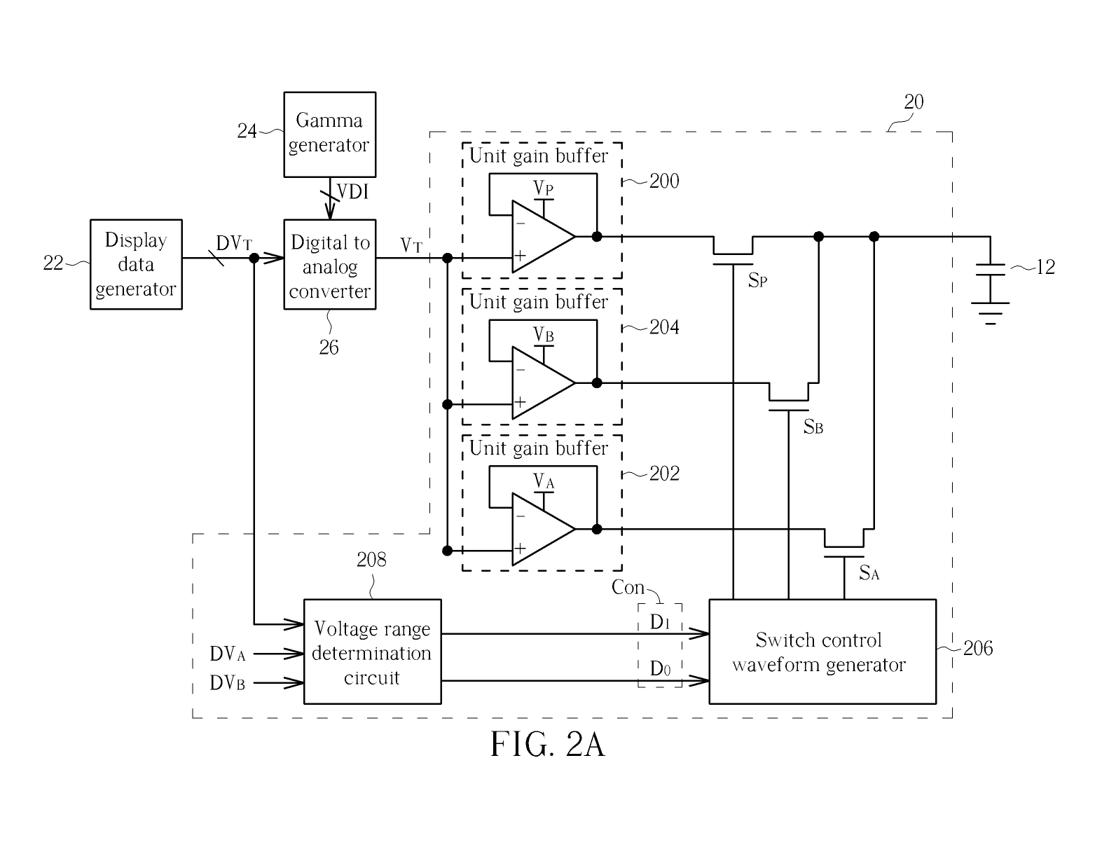

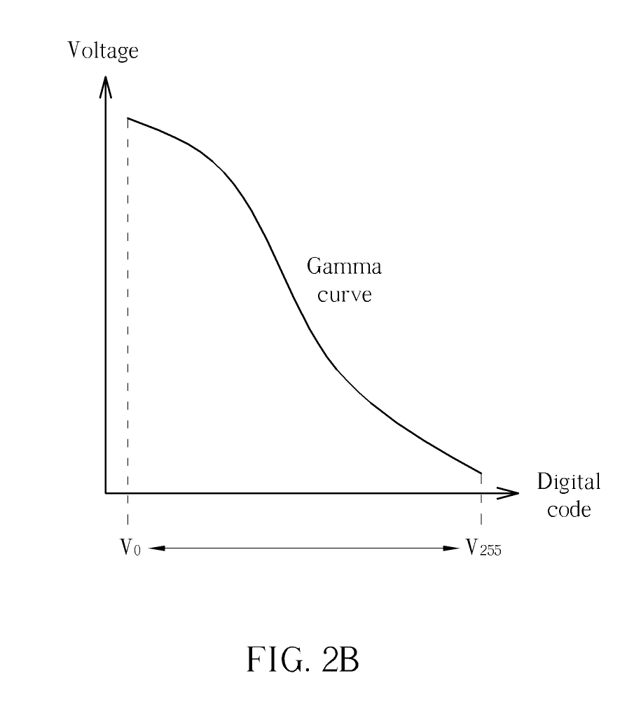

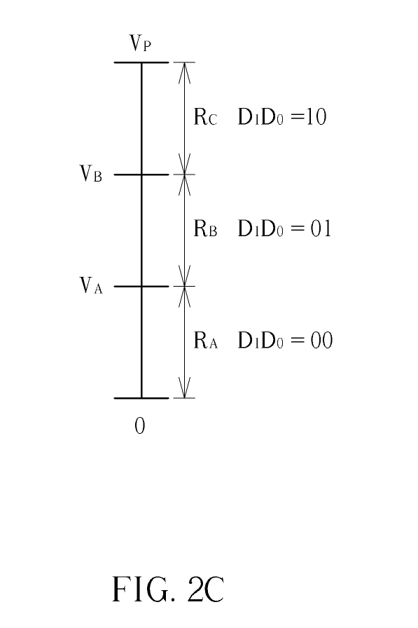

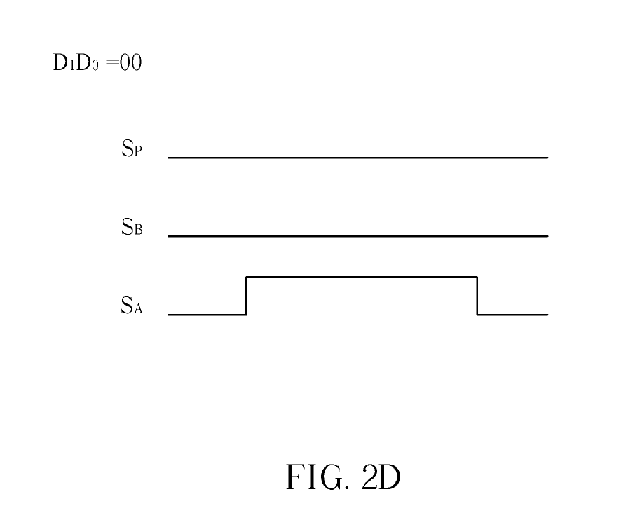

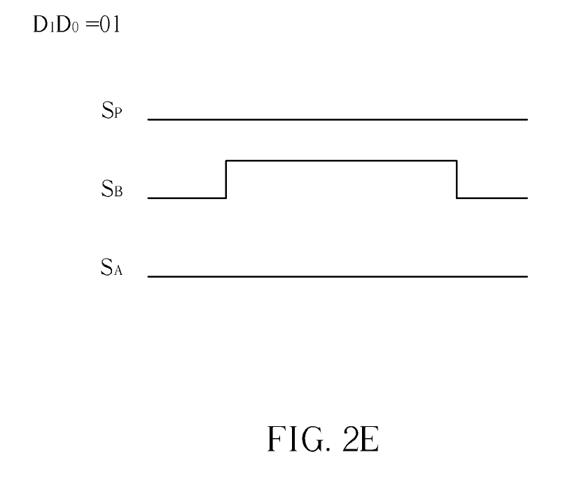

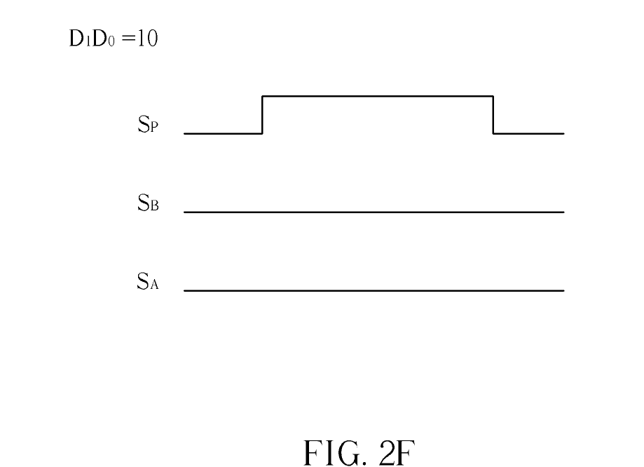

Please refer to FIG. 2A, which is a schematic diagram of a charging system 20 according to an embodiment of the present invention. As shown in FIG. 2A, the charging system 20 is utilized for charging the capacitor 12, and includes unit gain buffers 200, 202, and 204, switches S_{P}, S_{A}, and S_{B}, and a switch control waveform generator 206. The unit gain buffer 200 is similar to the unit gain buffer 10, and is driven by a driving voltage V. The unit gain buffer 200 includes a positive input terminal for receiving a target voltage V_{T}, and a negative input terminal coupled to an output terminal of the unit gain buffer 200 to form a negative feedback loop, to maintain the output voltage at the target voltage V_{T}. The unit gain buffers 202 and 204 are similar to the unit gain buffer 200. The unit gain buffers 202 and 204 are driven by driving voltage V_{A} and V_{B} respectively, wherein the driving voltage V_{P} is a maximum driving voltage among the driving voltages V_{P}, V_{A} and V_{B} and the target voltage V_{T} is normally set to be equal or less than the driving voltage V_{P} (e.g. the driving voltage V_{P} is the upper bound of the target voltage V_{T}), such that one of the unit gain buffers 200, 202 and 204 can maintain the output voltage at the target voltage V_{T}. The switches S_{P}, S_{A}, and S_{B} are coupled between the driving voltages V_{P}, V_{A} and V_{B} and the capacitor 12 respectively (e.g. coupled to the driving voltages V_{P}, V_{A} and V_{B} through the output terminals of the unit gain buffers 200, 202 and 204). The switch control waveform generator 206 is coupled to control terminals of the switches S_{P}, S_{A}, and S_{B}, and controls one of the switches S_{P}, S_{A}, and S_{B} to be turned on in one cycle according to a control signal Con, which includes control codes D₀ and D₁, to enable a specific driving voltage among the driving voltages V_{P}, V_{A} and V_{B} to drive corresponding one of the unit gain buffers 200, 202 and 204 to charge the capacitor 12. As a result, the switch control waveform generator 206 can flexibly switch a charging source of the capacitor 12 according to the control signal Con, to reduce power consumption.

In detail, when the driving voltage V_{A} is a driving voltage which is greater than and also the nearest to the target voltage V_{T} among the driving voltages V_{P}, V_{A} and V_{B}, the switch control waveform generator 206 can control the switch S_{A} to be turned on in one cycle, to enable the driving voltage V_{A} to drive the unit gain buffer 202 to charge the capacitor 12. In such a situation, total power consumption caused by charging the capacitor 12 is P=I*V=(V_{T}*C*F) *V_{A}. Since the driving voltage V_{A} is less than the driving voltage V_{P}, the total power consumption caused by charging the capacitor 12 with the charging system 20 is less than total power consumption caused by charging the capacitor 12 with the conventional unit gain buffer 10: P=I*V=(V_{T}*C*F)*V_{P}, i.e. the capacitor 12 is charged to the target voltage V_{T} by the driving voltage V_{A} which is less than the driving voltage V_{P}, and thus power consumption can be reduced. Similarly, when the switch control waveform generator 206 control the switch S_{B} to be turned on in one cycle, to enable the driving voltage V_{B} to drive the unit gain buffer 204 to charge the capacitor 12, the total power consumption caused by charging the capacitor 12 with the charging system 20 is also less than total power consumption caused by charging the capacitor 12 with the conventional unit gain buffer 10. As a result, the charging system 20 can flexibly switch the charging source of the capacitor 12 according to the target voltage V_{T}, to reduce power consumption.

For example, please refer to FIG. 2A together with FIG. 2B to FIG. 2F. FIG. 2B is a schematic diagram of a voltage to digital code conversion information VDI; FIG. 2C is a schematic diagram of dividing the driving voltage V_{P} into ranges R_{A}, R_{B}, and R_{C}; FIG. 2D to FIG. 2F are schematic diagrams of switches S_{P}, S_{A}, and S_{B} to be turned on in the cycle under different conditions. As shown in FIG. 2A, a display data generator 22 outputs a digital code DV_{T} of the target voltage V_{T}, e.g. 8 bits. A gamma generator 24 divides a gamma curve to correspond different digital codes to different voltages to generate the voltage to digital code conversion information VDI, e.g. the 8-bit digital codes are corresponding to 256 voltages as shown in FIG. 2B. A digital to analog converter 26 generates the target voltage V_{T} in an analog form according to the digital code DV_{T} of the target voltage V_{T} and the voltage to digital code conversion information VDI.

In this embodiment, the charging system 20 further includes a voltage range determination circuit 208. The voltage range determination circuit 208 divides the maximum driving voltage V_{P} among the driving voltages V_{P}, V_{A} and V_{B}(e.g. the upper bound of the target voltage V_{T}) to the ranges R_{A}, R_{B}, and R_{C} according to the voltages V_{P}, V_{A} and V_{B}, and determines the target voltage V_{T} located in one of the ranges R_{A}, R_{B}, and R_{C}, to generate the control signal Con, wherein the range R_{A} has a lower limit of voltage 0 and an upper limit of the voltage V_{A}, the range R_{B} has a lower limit of the voltage V_{A} and an upper limit of the voltage V_{B}, and the range R_{C} has a lower limit of the voltage V_{B} and an upper limit of the voltage V_{P}. In the case that the voltage range determination circuit 208 is a digital circuit, the voltage range determination circuit 208 receives the digital codes DV_{T}, DV_{A}, and DV_{B} of the target voltage V_{T} and the voltages V_{A} and V_{B}, to determine the target voltage V_{T} located in one of the ranges R_{A}, R_{B}, and R_{C}, and generate the control signal Con, which includes the control codes D₀ and D₁. For example, when the target voltage V_{T} is located in the range R_{A}, the control signal Con is D₁D₀=00, when the target voltage V_{T} is located in the range R_{B}, the control signal Con is D₁D₀=01, and when the target voltage V_{T} is located in the range R_{C}, the control signal Con is D₁D₀=10. In such a situation, the switch control waveform generator 206 switches a charging source of the capacitor 12 when the control signal Con indicates different control codes D₁ and D₀, i.e. different ranges, so as to reduce power consumption.

For example, as shown in FIG. 2D to FIG. 2F, when the target voltage V_{T} is located in the range R_{A}, the control signal Con(D₁D₀=00) indicates the switch control waveform generator 206 to control the switch S_{A} to be turned on in one cycle, to enable the driving voltage V_{A} to drive the unit gain buffer 202 to charge the capacitor 12; when the target voltage V_{T} is located in the range R_{B}, the control signal Con(D₁D₀=01) indicates the switch control waveform generator 206 to control the switch S_{B} to be turned on in one cycle, to enable the driving voltage V_{B} to drive the unit gain buffer 204 to charge the capacitor 12; when the target voltage V_{T} is located in the range R_{C}, the control signal Con(D₁D₀=10) indicates the switch control waveform generator 206 to control the switch S_{P} to be turned on in one cycle, to enable the driving voltage V_{C} to drive the unit gain buffer 200 to charge the capacitor 12. As a result, when the target voltage V_{T} is relatively low, the present invention can enable the driving voltages which consume less power to drive the corresponding unit gain buffer to charge capacitor 12, to reduce power consumption.

Noticeably, the spirit of the present invention is to flexibly switch the charging source of the capacitor 12, to reduce power consumption. Those skilled in the art can make modifications and alterations accordingly. For example, the above switches S_{P}, S_{A}, and S_{B} are illustrated as MOSFET, which are not limited to NMOS, PMOS, or CMOS, and can be other types of switch. Besides, number of driving voltages and corresponding components is not limited to which shown in the above embodiment, and can be other numbers, i.e. the present invention is not limited to determine the target voltage V_{T} located in one of the three ranges according to three driving voltages, wherein number of ranges can be any one.

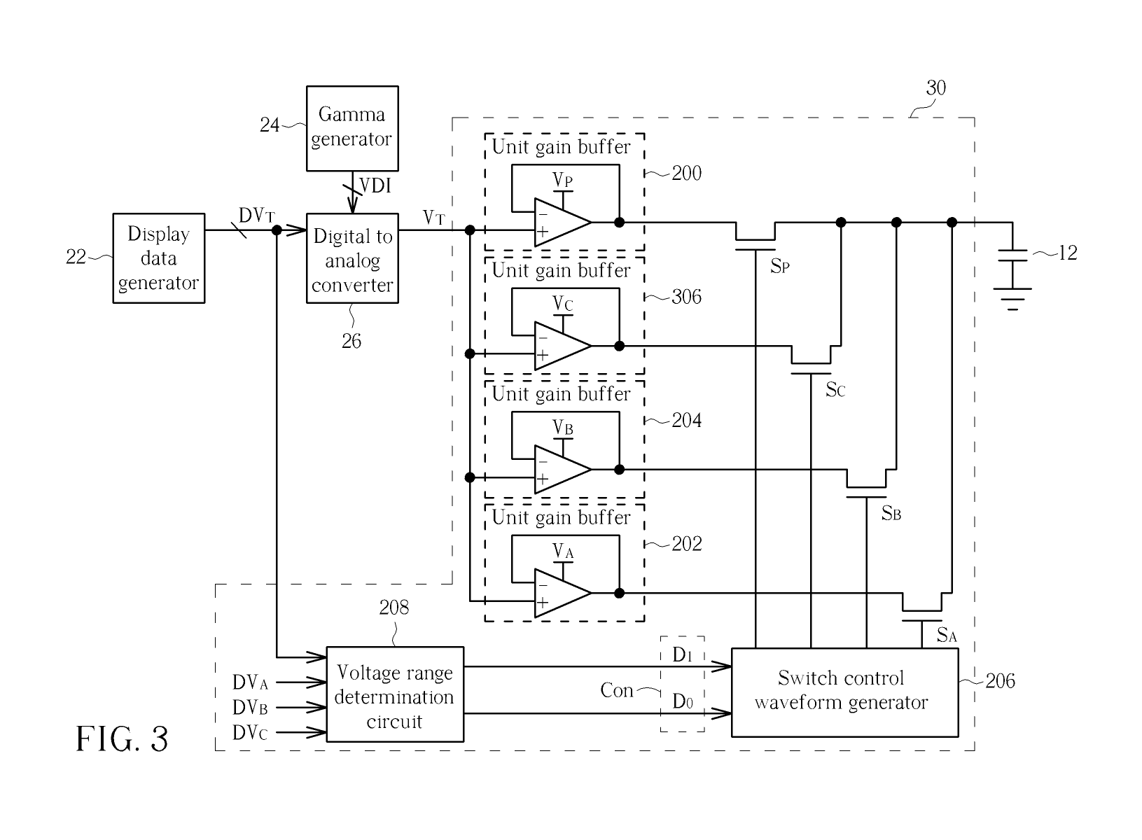

For example, please refer to FIG. 3. FIG. 3 is a schematic diagram of a charging system 30 according to another embodiment of the present invention. As shown in FIG. 3, the charging system 30 is similar to the charging system 20, and thus components and signals with similar functions are denoted by the same symbols. The main difference between the charging system 30 and the charging system 20 is that the charging system 30 further includes a unit gain buffer 306 and a switch S_{C}. The unit gain buffer 306 is similar to the unit gain buffer 200, and is driven by a driving voltage V_{C} (the driving voltage V_{C} is greater than the driving voltage V_{B} and less than the driving voltage V_{P}). The switch S_{C} is coupled between the driving voltage V_{C} and the capacitor 12 (e.g. coupled to the driving voltage V_{C} through the output terminal of the unit gain buffers 306). In such a situation, the voltage range determination circuit 208 further determines whether the target voltage V_{T} is located in a range R_{D} according to a digital code DV_{S} of the driving voltage V_{C}, and generates the control signal Con correspondingly, wherein the range R_{D} has a lower limit of voltage V_{C} and an upper limit of the voltage V_{P}, and the range R_{C} has a lower limit of the voltage V_{B} and an upper limit of the voltage V_{C}. As a result, the charging system 30 can enable the driving voltage V_{C} to drive the unit gain buffer 306 to charge the capacitor 12 when the control signal Con indicates that the target voltage V_{T} is located in range R_{D}, to reduce power consumption.

Moreover, in the above embodiments shown in the FIG. 2A and FIG. 3, the voltage range determination circuit 208 is a digital circuit and determines in which range the target voltage V_{T} is located to generate the control codes D₀ and D₁ as the control signal Con, but the method for generating control signal Con is not limited to this. In other embodiments, the charging systems 20 and 30 do not include voltage range determination circuit 208 (not shown), and directly utilize at least one of the digital codes among the digital code DV_{T} of the target voltage V_{T} as the control signal Con. For example, if the digital code DV_{T} of the target voltage V_{T} has 8 bits, e.g. B₇ to B₀, since several most significant bits of the digital code DV_{T} can approximately divide the driving voltage V_{P} to at least one range, the charging system 20 can divide the driving voltage V_{P} to three ranges according to the digital codes B₇B₆, and then utilize the digital codes B₇B₆ as the control signal Con to control the switch control waveform generator 206, wherein the function of the digital codes B₇B₆ is similar to the control codes D₀, and D₁, and the charging system 30 can divide the driving voltage V_{P} to four ranges according to the digital codes B₇B₆B₅, and then utilize the digital codes B₇B₆B₅ as the control signal Con to control the switch control waveform generator 206, wherein the function of the digital codes B₇B₆B₅ is similar to the control codes D₀, and D₁.

Moreover, in the above embodiments shown in the FIG. 2A and FIG. 3, the voltage range determination circuit 204 is a digital circuit and determines in which range the target voltage V_{T} is located to generate the control codes D₀ and D₁ as the control signal Con, but the voltage range determination circuit can also be realized as an analog circuit. For example, the voltage range determination circuits 208 included in the charging systems 20 and 30 can be analog circuits for receiving the target voltage V_{T} and the driving voltages V_{A}, V_{B} and V_{C}, to determine the target voltage V_{T} located in one of the ranges R_{A}, R_{B}, R_{C}, and R_{D} (e.g. comparing the target voltage V_{T} with the driving voltages V_{A}, V_{B} and V_{C} by a plurality of comparators for determination), and generate the control signal Con.

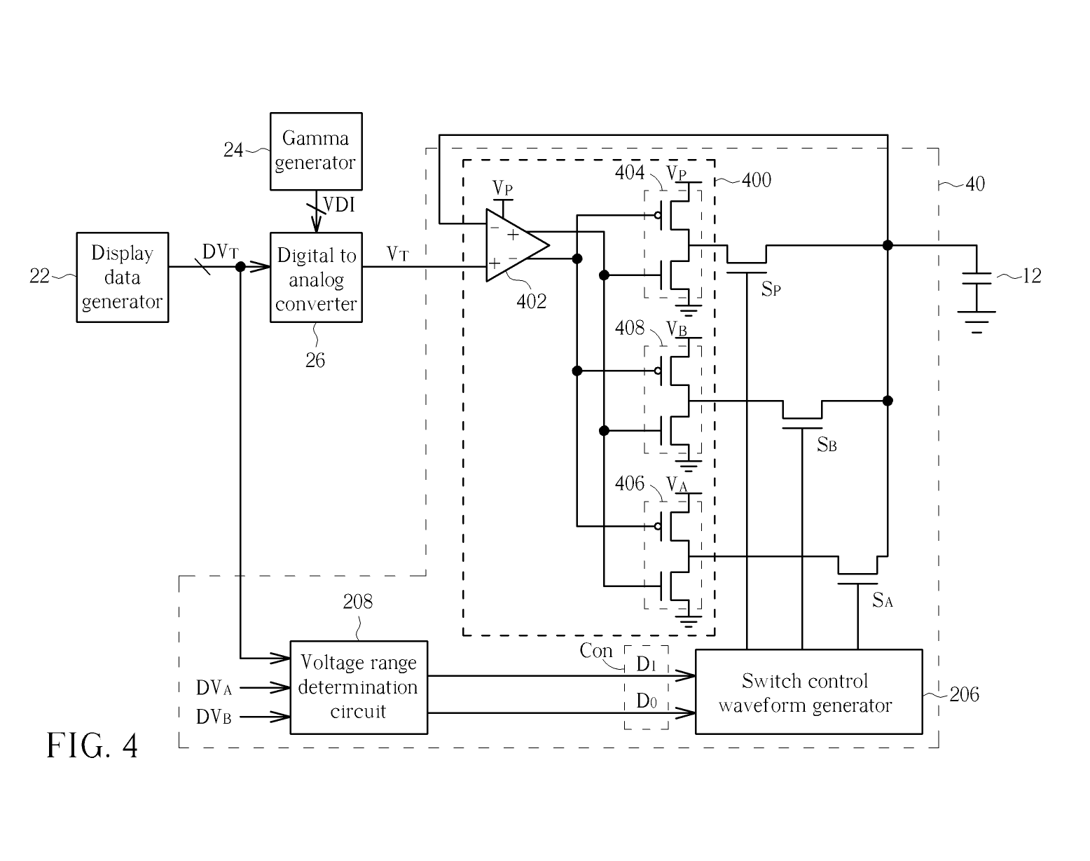

On the other hand, structure of driving voltages and corresponding components is not limited to which shown in the above embodiment (e.g. driving a plurality of unit gain buffers by a plurality of driving voltages, and controlling switches to enable one of the plurality of driving voltages to drive the corresponding unit gain buffer to charge the capacitor 12), and can be other structures. For example, please refer to FIG. 4, which is a schematic diagram of a charging system 40 according to an embodiment of the present invention. As shown in FIG. 4, the charging system 40 is similar to the charging system 20, and thus components and signals with similar functions are denoted by the same symbols. The main difference between the charging system 40 and the charging system 20 is that the charging system 40 includes only a unit gain buffer 400. The unit gain buffer 400 includes a differential input pair 402 and class AB output stages 404, 406, and 408. The differential input pair 402 is driven by the maximum driving voltage V_{P} among the driving voltages V_{P}, V_{A} and V_{B} and the class AB output stages 404, 406, and 408 are driven by the driving voltages V_{P}, V_{A} and V_{B} respectively, and include output terminals coupled to switches S_{P}, S_{A}, and S_{B}.

In such a situation, when the switch control waveform generator 206 controls a specific switch among the switch S_{P}, S_{A}, and S_{P} to be turned on according to the range which the target voltage V_{T} is located in, to enable a specific driving voltage to drive the corresponding output stage to charge the capacitor 12, a negative input terminal of the unit gain buffer 400 is coupled to the output terminal of the corresponding output stage through the specific switch, to charge the capacitor 12 to the target voltage V_{T}. As a result, the differential input pair 402 is utilized for feedback control with low loading and thus low power consumption. The main portion of power consumption is caused by charging the capacitor 12 with the output stage. Therefore, when the target voltage V_{T} is relatively low, this embodiment can enable driving voltages which consume less power to drive the corresponding unit gain buffer to charge capacitor 12, to reduce power consumption. Furthermore, the circuit of this embodiment is simpler than the charging system 20 since the differential input pair 402 is commonly used.

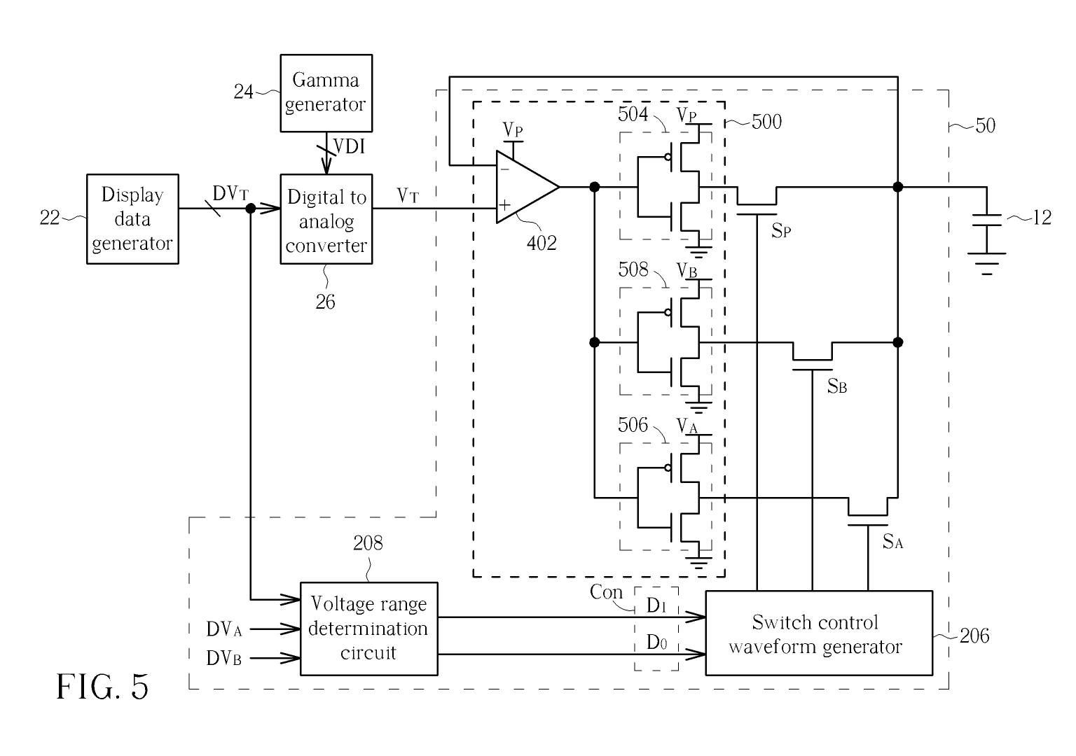

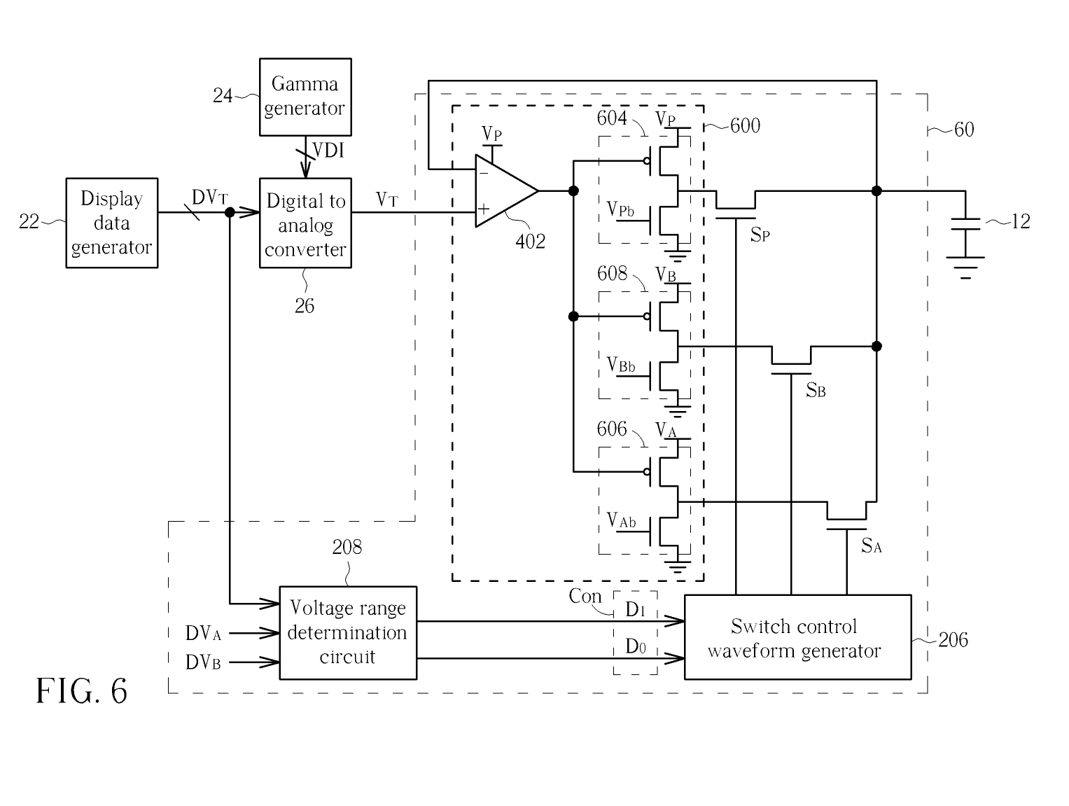

In the charging system 40 shown in FIG. 4, the output stages 404, 406, 408 included in the unit gain buffer 400 are class AB output stages, but the output stage included in the unit gain buffer 400 can also be other class output stages in different embodiments. For example, please refer to FIG. 5 and FIG. 6. FIG. 5 and FIG. 6 are schematic diagrams of charging systems 50 and 60 according to embodiments of the present invention. As shown in FIG. 5 and FIG. 6, the charging systems 50 and 60 are similar to the charging system 20, and thus components and signals with similar functions are denoted by the same symbols. The main difference between the charging system 20 and the charging systems 50, 60 is that output stages 504, 506, 508 included in a unit gain buffer 500 are class B output stages in the charging system 50 and output stages 604, 606, 608 included in a unit gain buffer 600 are class A output stages in the charging system 60, wherein the output stages 604, 606, 608 are controlled by bias voltages V_{Pb}, V_{Ab}, V_{Pb}. Other detailed operation methods about the charging systems 50 and 60 can be referred to the above description about the charging systems 20 and further description is omitted here for brevity.

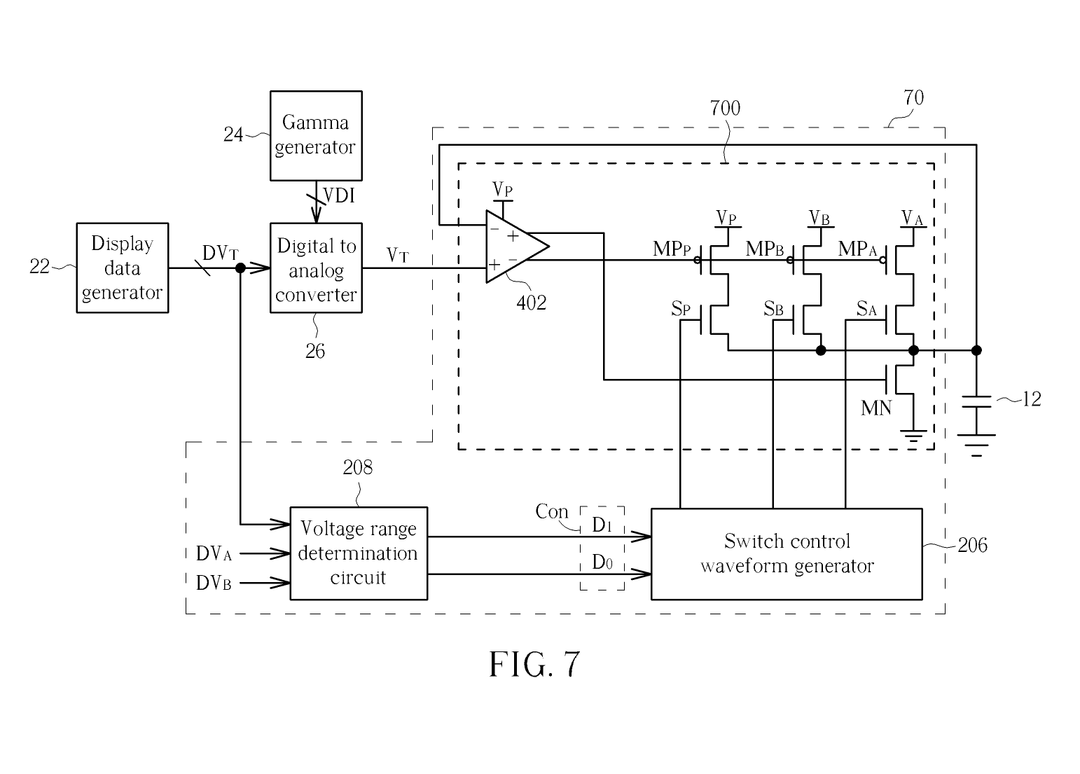

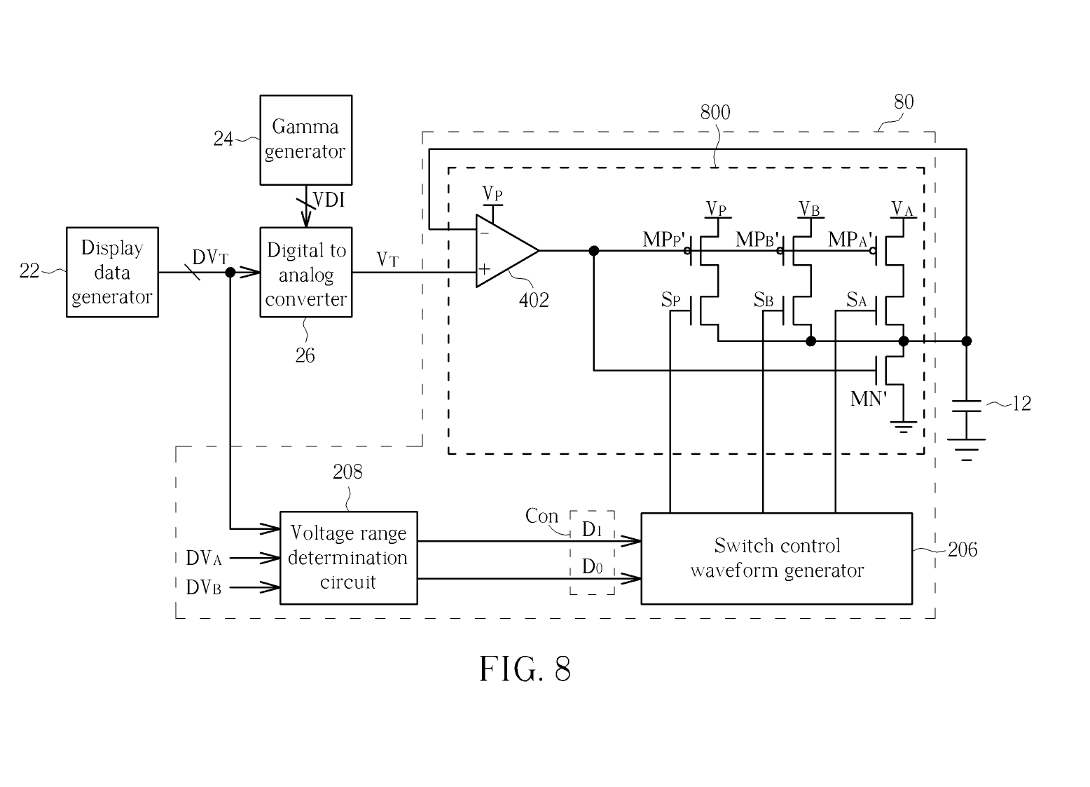

Moreover, for further simplifying the circuit, the embodiments with class AB or B output stages can use an N-type transistor commonly. In detail, please refer to FIG. 7 and FIG. 8. FIG. 7 and FIG. 8 are schematic diagrams of charging systems 70 and 80 according to embodiments of the present invention. As shown in FIG. 7 and FIG. 8, the charging systems 70 and 80 are similar to the charging systems 40 and 50 respectively, and thus components and signals with similar functions are denoted by the same symbols. The main difference between the charging system 70 and the charging system 40 is that a unit gain buffer 700 can use an N-type transistor MN commonly since all the class AB or B output stages of the N-type transistors are coupled to ground, and all the control terminals of the N-type transistors are coupled to the differential input pair 402 (i.e. the switches S_{P}, S_{A}, S_{B} are coupled to P-type transistors MP_{P}, MP_{A}, MP_{B} respectively, which respectively form the class AB output stages driven by the driving voltages V_{P}, V_{A}, V_{B} with the N-type transistor MN when the switches S_{P}, S_{A}, S_{P} the are turned on respectively). Similarly, P-type transistors MP_{P}′, MP_{A}′, MP_{B}′ respectively form the class B output stages driven by the driving voltages V_{P}, V_{A}, V_{B} with the N-type transistor MN. As a result, compared with the charging systems 40 and 50, the charging systems 70, 80 can use an N-type transistor commonly to further reduce circuit complexity.

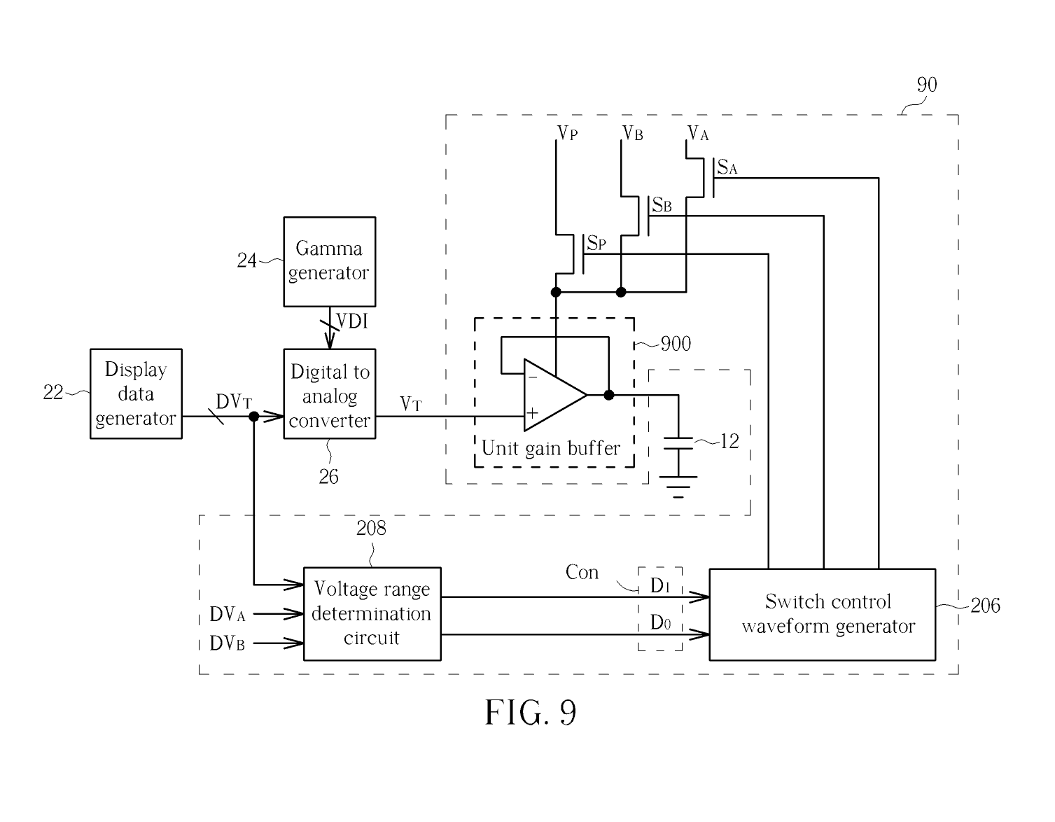

In addition, power consumption can be reduced by switching different driving voltages to drive the same unit gain buffer. In detail, please refer to FIG. 9. FIG. 9 is a schematic diagram of a charging system 90 according to an embodiment of the present invention. As shown in FIG. 9, the charging system 90 is similar to the charging system 40, and thus components and signals with similar functions are denoted by the same symbols. The main difference between the charging system 90 and the charging system 40 is that a unit gain buffer 900 which is included in charging system 90 includes only an output stage. Therefore, the switches S_{P}, S_{A}, S_{B} are coupled between the driving voltages and the unit gain buffer 900. The control signal Con controls a specific switch among switches S_{P}, S_{A}, S_{B} to be turned on, to enable a specific driving voltage to drive the unit gain buffer 900 to charge the capacitor 12. As a result, this embodiment can enable driving voltages which consume less power to drive the same unit gain buffer 900 to charge capacitor 12, to reduce power consumption. Furthermore, the circuit of this embodiment is simpler than the above embodiments, but the unit buffer 900 need a settling time to maintain stable when switching different driving voltages.

Please note that the above charging systems 40 to 90 can be realized by three driving voltages and can also be realized by four driving voltages as shown in the charging system 30 as well. The corresponding modification can be referred to the above description about the charging system 30 and further description is omitted here for brevity. Moreover, in the above embodiments, a specific charging system is realized by a specific structure. In other embodiments, a charging system can be realized by combining multiple characteristics of specific structures.

In the prior art, the method of charging the capacitor 12 with only the unit gain buffer 10 causes unnecessary power consumption when the target voltage is relatively low. In comparison, the present invention can flexibly switch the charging source of the capacitor 12 and enable driving voltages which consume less power to drive the corresponding unit gain buffer to charge capacitor 12 when the target voltage V_{T} is relatively low, to reduce power consumption.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A charging system for charging a capacitor, comprising:
at least one unit gain buffer, driven by a plurality of driving voltages, each unit gain buffer comprising a positive input terminal for receiving a target voltage and a negative input terminal coupled to an output terminal of the each unit gain buffer;
a plurality of switches, coupled between the plurality of driving voltages and the capacitor; and
a switch control waveform generator, coupled to the plurality of switches, for switching on a specific switch of the plurality of switches within a period according to a control signal, to enable a specific driving voltage among the plurality of driving voltages to drive one of the at least one unit gain buffer to charge the capacitor.

2. The charging system of claim 1, wherein the specific driving voltage is a driving voltage which is greater than and nearest to the target voltage among the plurality of driving voltages.

3. The charging system of claim 1 further comprising a voltage range determination circuit, for dividing a maximum driving voltage among the plurality of driving voltages to a plurality of ranges according to the plurality of driving voltages, and determining the target voltage located in one of the plurality of ranges, to generate the control signal.

4. The charging system of claim 1, wherein the at least one unit gain buffer comprises a plurality of unit gain buffers driven by the plurality of driving voltages respectively.

5. The charging system of claim 1, wherein the at least one unit gain buffer comprises a unit gain buffer, the unit gain buffer comprises:
a differential input pair, driven by a maximum driving voltage among the plurality of driving voltages; and
a plurality of output stages, driven by the plurality of driving voltages respectively, comprising a plurality of output terminals coupled to the plurality of switches;
wherein the negative input terminal of the unit gain buffer is coupled to one of the plurality of output terminals of the plurality of output stages through the specific switch among the plurality of switches.

6. The charging system of claim 5, wherein the plurality of output stages comprises a plurality of class AB output stages.

7. The charging system of claim 6, wherein the plurality of class AB output stages commonly use an N-type transistor.

8. The charging system of claim 5, wherein the plurality of output stages comprises a plurality of class B output stages.

9. The charging system commonly of claim 8, wherein the plurality of class B output stages use an N-type transistor.

10. The charging system of claim 5, wherein the plurality of output stages comprises a plurality of class A output stages.

11. The charging system of claim 1, wherein the at least one unit gain buffer comprises a unit gain buffer, the plurality of switches are coupled between the plurality of driving voltages and the unit gain buffer, respectively, and the control signal switches on the specific switch among the plurality of switches, to enable the specific driving voltage to drive one of the at least one unit gain buffer to charge the capacitor.

12. A charging system for charging a capacitor, comprising:
a unit gain buffer, comprising:
a differential input pair, driven by a maximum driving voltage among a plurality of driving voltages, comprising a positive input terminal for receiving a target voltage; and
a plurality of output stages, driven by the plurality of driving voltages respectively, comprising a plurality of output terminals;
a plurality of switches, coupled between the plurality of output terminals of the plurality of output stages and the capacitor; and
a switch control waveform generator, coupled to the plurality of switches, for switching on a specific switch of the plurality of switches within a period according to a control signal, to enable a specific driving voltage among the plurality of driving voltages to drive one of the plurality of output stages to charge the capacitor;
wherein a negative input terminal of the unit gain buffer is coupled to one of the plurality of output terminals of the plurality of output stages through the specific switch among the plurality of switches.

13. The charging system of claim 12, wherein the specific driving voltage is a driving voltage which is greater than and nearest to the target voltage among the plurality of driving voltages.

14. The charging system of claim 12 further comprising a voltage range determination circuit, for dividing a maximum driving voltage among the plurality of driving voltages to a plurality of ranges according to the plurality of driving voltages, and determining the target voltage located in one of the plurality of ranges, to generate the control signal.

15. The charging system of claim 12, wherein the plurality of output stages comprises a plurality of class AB output stages.

16. The charging system of claim 15, wherein the plurality of class AB output stages commonly use an N-type transistor.

17. The charging system of claim 12, wherein the plurality of output stages comprises a plurality of class B output stages.

18. The charging system of claim 17, wherein the plurality of class B output stages use commonly an N-type transistor.

19. The charging system of claim 12, wherein the plurality of output stages comprises a plurality of class A output stages.

20. A charging system for charging a capacitor, comprising:
a unit gain buffer, comprising a positive input terminal for receiving a target voltage and a negative input terminal coupled to an output terminal of the unit gain buffer;
a plurality of switches, coupled between a plurality of driving voltages and the capacitor; and
a switch control waveform generator, coupled to the plurality of switches, for switching on a specific switch of the plurality of switches within a period according to a control signal, to enable a specific driving voltage among the plurality of driving voltages to drive one of the at least one unit gain buffer to charge the capacitor.

21. The charging system of claim 20, wherein the specific driving voltage is a driving voltage which is greater than and nearest to the target voltage among the plurality of driving voltages.

22. The charging system of claim 20, further comprising a voltage range determination circuit, for dividing a maximum driving voltage among the plurality of driving voltages to a plurality of ranges according to the plurality of voltages, and determining the target voltage located in one of the plurality of ranges, to generate the control signal.
